(19) United States
(12) Patent Application Publication
(10) Pub. No.: US 2008/0294078 A1
(43) Pub. Date: Nov. 27, 2008

(54) Manual Device, Method and their Use for the Stimulation of Body regions via the Skin, in particular of the Female Breast

(76) Inventors: Auguste Leurs, Krefeld (DE); Werner Leurs, Krefeld (DE)

Correspondence Address: LERNER GREENBERG STEMER LLP, P O BOX 2480, HOLLYWOOD, FL, 33022-2480, US

(21) Appl. No.: 12/122,905

(22) Filed: May 19, 2008

Related U.S. Application Data
(63) Continuation of application No. PCT/DE2006/002040, filed on Nov. 17, 2006.

(30) Foreign Application Priority Data
Nov. 17, 2005 (DE) DE102005055404.0

(51) Int. Cl. A61H 7/00

(52) U.S. Cl. 601/137; 601/84

(57) ABSTRACT

A manual device made of a soft material is composed of a top face and a bottom face forming an intermediate space that is embodied so as to accommodate at least one hand. At least two separate openings are provided for the fingers of the hand while areas on which stimulation zones are configured are designed at least in the area of the palm and the fingers. Also disclosed are a stimulation method and the use.

The invention relates to a manual device, a method and their use for the stimulation of body regions via the skin, in particular of the female breast.

From practical experience the problem has been known that the size of at least one, usually even both breasts, does not correspond to the wishes of the person concerned and that a certain increase in size is desired.

In the case of such a desire, there is the option of supporting or accentuating the existing anatomy through corresponding pieces of clothing, such as push-up bras or the like. But only the alteration of the breast size by means of surgical intervention which by now has become quite popular and during which a liquid-filled implant is usually inserted has so far made a permanently larger breast possible.

The usual disadvantages and risks of an operation due to the anesthesia during surgery, the danger of complications and potential rejection risks with regard to the implant are augmented by scarring, the usually unnatural appearance of the breast enlarged in this way, and the image disadvantage as well as the high costs of surgical breast enlargement.

Finally, having foreign objects imbedded in the body that moreover are connected with latent risks such as leaking of the filling agent of the implant, reduced impermeability or rupture during mechanical stress, e.g. in the event of an accident or due to changes in the air pressure may also be physically and/or psychologically unpleasant for the person concerned.

Among the usual massage devices are the horsehair glove and the massage brush. The latter has on its active side a large number of spikes and cones which when guided across the skin cause a slight indention of the latter and, consequently, a local hyperemia. A massage brush is described in DE 808 747 PS, for example, which may be made of rubber or latex and which forms a hollow space that is closed on all sides and which is provided with bristle bunches or cones. According to the document, the construction of the massage brush is rigid and careful stimulation via the individual fingers is not possible. From DE 20 2005 015 670 U1, a massage glove with an all-around exterior cover of nubs has been known which is formed by means of a single cast. The disadvantage here is the fact that due to its construction the glove is bulky, and careful massage and stimulation can not be guaranteed. The choice of latex or rubber may furthermore cause irritations on the surface of the skin. In case of a latex/rubber allergy, the glove can not be used.

DE 82 36 688 describes a massage glove that is made from a segment of a belt, with the segment being folded in its center and the lateral edges that lie on top of each other being sewn together. On its narrow side it has an opening through which the hand can slide in, and on at least one exterior surface it has bristles, and the foldover is unstitched and the edge of the opening has a border.

In French patent application no. 7812063, a massage brush is described which is provided with asymmetric cones made of a soft, elastic, deformable material on its active side, with each individual cone having a concave and a convex area opposite each other. This provides the aforementioned asymmetric cones with greater bend resistance when pressure is exerted on its convex part and less bend resistance when pressure is exerted on its concave part. In addition, the cones are alternately arranged front side to backside, i.e. one cone whose concave side is pointed in one direction is next to a cone whose concave side is pointed in the other direction.

The objective of the invention is to avoid the aforementioned disadvantages and to provide a manual device with which the stimulation of body zones, particularly of the female breast, occurs via the skin.

Another subject of the invention at hand is a method and its use for the stimulation of body zones via the skin, in particular of the female breast, in order to increase, within certain limits, the breast size without any risk.

This task is solved by a manual device in which the device is made of a soft elastic material and consists of an upper and a lower part that form an interstice designed to accommodate at least one hand, with at least two separate openings being provided for the fingers of at least one hand and areas being formed in the region of the palm and of the fingers in which massage areas are located.

Within the framework of the invention at hand, the term “soft elastic material” is to be understood as textile material. This may involve material made of natural fibers such as cotton, viscose, flax, coconut, sisal or sheep's wool or the like, as well as from the spectrum of chemical fibers. Modified chemical fibers may consist of modified natural macromolecules such as acetates. They include fibers made of cellulose acetate with an acetyl group contents between 74 and 92%. In addition, they include alginate fiber materials made from regenerated cellulose that are produced in accordance with the viscose method.

Elastic fibers are usually understood to be those made from natural or synthetic polyisoprenes which may also be made from copolymerisates.

They also include rayon which in general consists of regenerated cellulose for fibers. Here, those made of cellulose ethers may be used as well. Likewise, protein fibers made of regenerated plant or animal proteins may be used. Corn, ardein from peanuts or casein from milk shall be named here as examples. The synthetic fibers are spun from polymers. The polymerisate fibers include, among others, chlorofibers such as Leavil, Movil, saran or similar ones.

In one embodiment of the invention at hand, the stimulation zones involve a textile material that is preferably made of terrycloth. This achieves a pleasant physical sensation and still guarantees the stimulation effect. Linen, sisal, coconut fibers or flax may be utilized in the massage areas.

In an additional embodiment, the device in accordance with the invention is provided with preferably symmetrical cones in the stimulation area that have alternating more and less flexible parts. In accordance with the invention, the cones consist of lamellas that are arranged to each other in crosswise or non-crosswise fashion and which, on the one hand, have increased bend resistance, thereby causing a “hard” touch with the skin if the cone lamellas are acted upon in longitudinal direction and the latter, on the other hand, having less bend resistance and therefor appearing “soft” on contact with the skin when the cone lamellas are acted upon laterally. The cones all have the same shape but are arranged in at least two angular directions in such a way that the skin on which the device in accordance with the invention is moved along is alternately subjected to the more flexible and to the less flexible cones.

In an additional embodiment of the manual device in accordance with the invention for the surface of the skin with at least one active side that is provided with a multitude of protruding cones made of a soft, elastic, deformable material that is characterized by the fact that the cones consist of lamellas that are arranged in crosswise or non-crosswise fashion and that are divided into at least two groups according to the angular direction of their lamellas, with the lamellas of one group on the active side of the manual device alternating with the cones of the other group.

In accordance with a preferred embodiment, the cones are produced as one piece together with their support base and made of a soft, rubber-like elastic material. The lamellas forming the cones are essentially arranged at a right angle on their support base and are in the shape of a circle segment that is connected to the support base at its bowstring, with the surface that envelops the lamella discs essentially having the shape of a spherical cap.

In a first embodiment, the cones consist of two lamellas that are arranged crosswise and that in a top view have the form of an “X”. The angular direction of the crossed lamellas of the cones belonging to one group differs from the angular direction of the crossed lamellas of the cones belonging to another group in that it is rotated around an axis that runs through the intersection point of the two crossed lamellas of the cones. Each cone has a symmetric shape with regard to the axis running through the intersection point of the two lamellas. The two crossed lamellas of each cone are essentially arranged at a right angle to each other while the cones of one group are rotated by 45° degrees against the cones of the other group. The crossed lamellas of the cones are advantageously incised at their point of intersection up to a part of their height.

In an additional embodiment, the cones do not consist of crossed lamellas but rather of lamellas that are essentially parallel to each other. The angular direction of the cone lamellas of one group is dependent on the position of the cone lamellas of the other group, with the cones being divided into four groups and the lamellas of the cones of one group being rotated by 45° or a multiple thereof against the lamellas of the cones of another group.

In accordance with the invention, the cones may be arranged in essentially parallel rows or in sinus-shaped rows, with two adjacent sinus-shaped rows then being in a phase contrast or arranged in concentric circles.

The manual device in accordance with the invention may consist of a stimulation zone in which the flexible support base of the cones is imbedded in a rigid foundation. It may also consist of a glove, i.e. of a pliable pocket, with the cones protruding on at least one side. In yet another embodiment, the manual device in accordance with the invention may be perforated in the area of the elastic support base of the cones and may be provided with a storage system containing, e.g., a cream, a lotion, oils or pharmaceutically active mixtures that are dispensed in small doses during the stimulation of the skin surface.

In an additional embodiment of the invention at hand, the manual device is provided on its side that is turned away from the body with a dispensing reservoir that is connected with the massage areas via a hose system. Viscous and/or fluid media are supplied to the massage areas via the hose system. The fluid media involve the compositions mentioned above that assure the stimulation of the skin. In this respect, the dispenser reservoir can be arranged only on the back of the hand. The inlet opening for the filling of the viscous and/or slightly fluid media is closed in detachable fashion with a one-way valve, e.g. a spherical valve or the like. By clenching one's fist or fists, the viscous and/or slightly fluid media are transported by means of the pressure from the dispenser reservoir via the hose system to the outlet openings of varying sizes. While the media are distributed over large areas at the large outlet openings, a micro-dosage is dispensed via the small openings only upon contact with the skin during the stimulation. Depending on the application, the device in accordance with the invention may be provided only with larger outlet openings or only with micro-outlet openings or with both outlets. For micro-dosage, the outlet openings have a diameter of up to 1 mm, and in the case of large-area dosage, a diameter of up to 4 mm. In one embodiment in which more viscous media are used, the device in accordance with the invention is equipped with outlet openings that have a diameter of 2.5 to 6 mm.

In another variant, the hoses from the dispenser reservoir run between the fingers. By closing the fingers, pressure is built up that transports the fluid media to the outlet openings. By using soft elastic or textile materials, dosing can occur over large areas with few outlet openings or in the form of micro-dosing via a larger number of outlet openings. The ratio of larger to smaller outlet openings can be 1 to 10 to 2 to 8.

If the manual device in accordance with the invention involves one that has lamellas, cones or the like in the area of the phalanx, the outlet openings may be arranged within this stimulation zone. In addition, larger outlet openings may be formed on the palm and on the second and/or third phalanxes.

The stimulation of the skin may occur, e.g., through resinoids, resins, concentrates and synthetic perfume components such as carbohydrates, alcohols, aldehydes, ketones, ethers, acids, esters, acectales, ketains, nitriles, etc. containing saturated and unsaturated compounds, aliphatic, carbocyclic and heterocyclic compounds. Silver fir oil, spruce needle oil and mountain pine oil, pine needle oil, juniper berry oil, lavender oil, rosemary oil, thyme oil, cedar wood oil, lemon oil, mandarin oil, bitter orange oil, palmarosa oil, geranium oil, petit grain oil, guajak wood oil, bornyl acetate, bornyl valerianate, benzyl acetate, benzyl alcohol, geraniol, heliotropin, linabol, phenyl ethyl alcohol, terpineol, cibet artificial, geraniol acetate, linalool, linalyl acetate, tetrahydrolinalool, lemon oil acetate, dihydromyrcenol, dihydromyrcenyl acetate, tetrahydromyrcenol, terpineol acetate, nopol, nopyl acetate, 2-phenyl ethanol, 2-phenylethyl acetate, benzyl alcohol, benzyl acetate, benzyl salicylate, benzyl benzoate, styralyl acetate, amyl salicylate, dimethyl benzyl carbinol, trichloromethylphenycarbinyl acetate, p-tert-butylcyclohexyl acetate, isononyl acetate, vetiveryl acetate, vetiverol, α-n-amyl cinammic aldehyde, α-hexyl cinammic aldehyde, 2-methyl-3-(p-tert-butylphenyl) propanal, 2-methyl-3-(p-isopropylphenyl) propanal, 3-(p-tert-butylphenyl) propanal, tricyclodecenyl acetate, tricyclodecenyl propionate, 4(4-hydroxy-4-methyl pentyl)-3-cyclohexenecarbaldehyde, 4-(4-methyl-3-pentanyl)-3-cyclohexenecarbaldhyde, 4-acetoxy-3-pentyltetrahydropyran, methyl dihydrojasmonate, 2-n-heptylcyclopentanon, 3-methyl-2-pentylcyclopentanon, n-decanal, n-dodecanal, 9-decanol-1, phenol ethyl isobutyrate, phenylacetaldehyde dimethyl acetate, phenylacetaldehyde, diethyl acetal, geranonitril, citronellonitril, cedryl acetate, 3-isocamphylcyclohexanol, cedryl methyl ether, isolongifolanon, aubepinenitril, aubepin, heliotropin, coumarin, eugenol, vanillin, diphenyl oxide, hydroxycitronellal, ionon, methyl ionon, isomethyl ionon, cis-3-hexenol and esters thereof, indane, musk, tetralin musk, isochroman musk, macrocyclic ketones, musk acrolactone shall be named as particularly preferred in this respect.

Relubricating agents, antimicrobial active agents, keratolytically and keratoplastically acting agents, antiphlogistics, pharmaceutical active agents and the like shall be mentioned as additional active agents for stimulation.

Relubricating agents within the framework of the invention at hand involve lipophile (fat-like) substances that are absorbed by the skin during the washing/cleaning process, thereby counteracting a defatting of the skin caused by the surface-active components of the corresponding cosmetic substances. Examples of relubricating agents, also called relubricants or overgreasing agents, are water-soluble triglycerides, (ethoxylized) partial glycerides, fatty acid alkanolamides, fatty acid polyglycol esters, straight-chained or ramified fatty acids and fatty alcohols as well as lanolin and lecithin derivatives.

Antimicrobial active agents are employed in order to destroy microorganisms or, respectively, to inhibit their growth which, in the case of a longer reaction time, will ultimately lead to their demise as well. Antimicrobial substances are mainly used as preserving agents in the field of cosmetics. Deodorizing substances may also have an antibacterial effect. They include the preserving agents p-hydroxybenzoic acid esters, imidazolidinyl urea, formaldehyde, sorbic acid, bronopol, dehydroacetic acid, benzoic acid, salicylic acid. Deodorizing active substances are Zinkrimoleat*, tridosan, undecylenic acid alkylolamide, citric acid triethyl ester, chlorhexidine and derivatives.

The hyperemizing active agents involve substances that stimulate the blood circulation of the skin, to with either by raising the skin temperature or by raising the skin turgor. Substances with an increased blood circulation promoting effect are primarily used in conjunction with massages to increase the blood circulation of the skin. They include ethereal oils such as mountain pine, lavender, rosemary, juniper berry, horse chestnut extract, birch leaf extract, hay flower extract, ethyl acetate, stinging nettle extract, camphor, menthol, nicotine acid and its esters, peppermint oil, rosemary extract, eucalyptus and larch turpentine oil.

The substances with a keratinizing effect involve those substances that promote the formation of keratin of the epithelium cells.

For a better understanding of the invention, two embodiments shown in the drawings will be described as examples, but not limited thereto.

Shown in the drawings are:

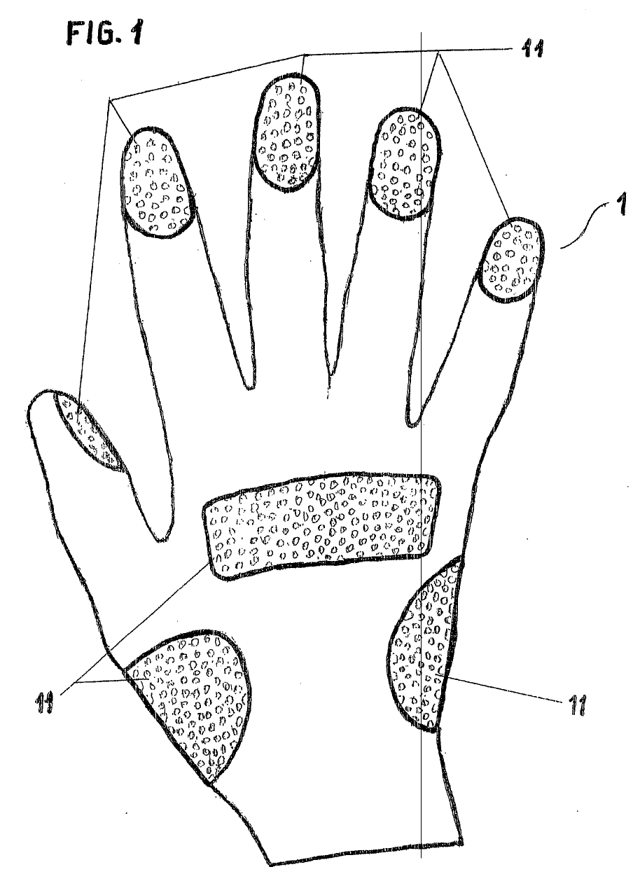

FIG. 1 representation of an embodiment of the manual device;

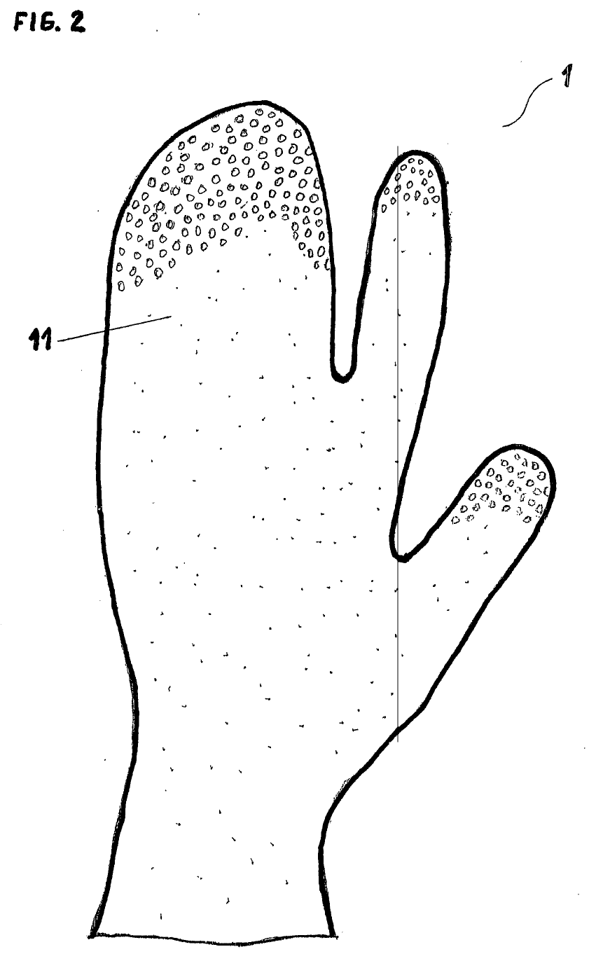

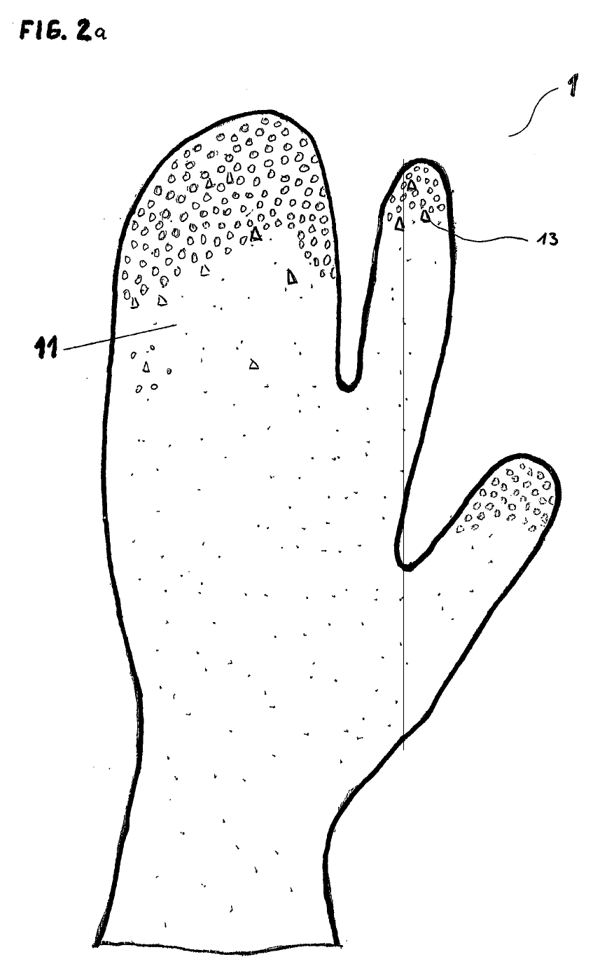

FIG. 2 representation of an additional embodiment of the manual device in accordance with the invention;

FIG. 2a representation of an additional embodiment of the manual device in accordance with the invention with a triangular design for the openings for the fluid media;

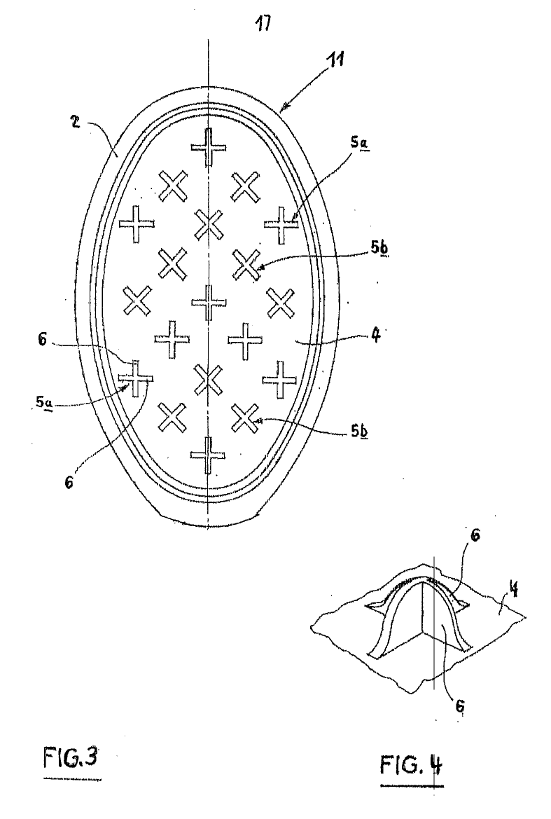

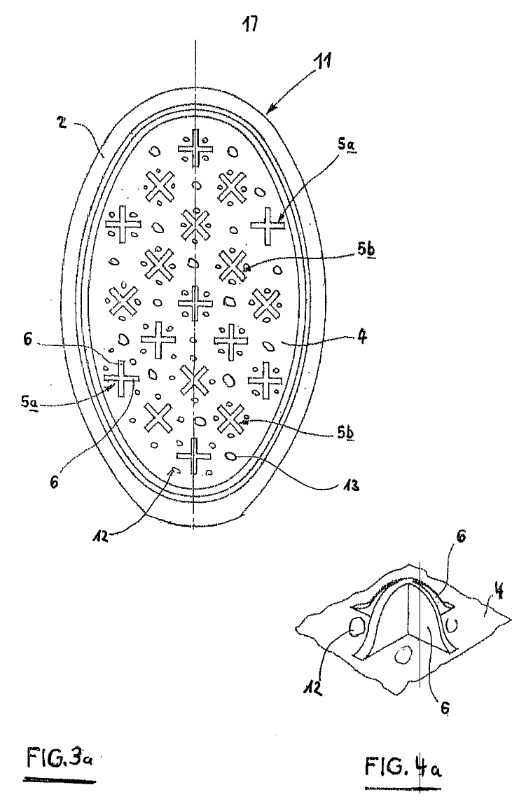

FIG. 3 a top view of a stimulation part in accordance with the invention in accordance with an embodiment of the invention;

FIG. 3a a top view of a stimulation part in accordance with the invention in FIG. 3 with openings of different sizes for the fluid or slightly viscous media;

FIG. 4 a perspective view on a larger scale of two crossed lamellas that form a cone as shown in FIG. 3 on the manual device;

FIG. 4a a perspective view on a larger scale of two crossed lamellas that form a cone, like in FIG. 3, with small openings for the fluid or slightly viscous media;

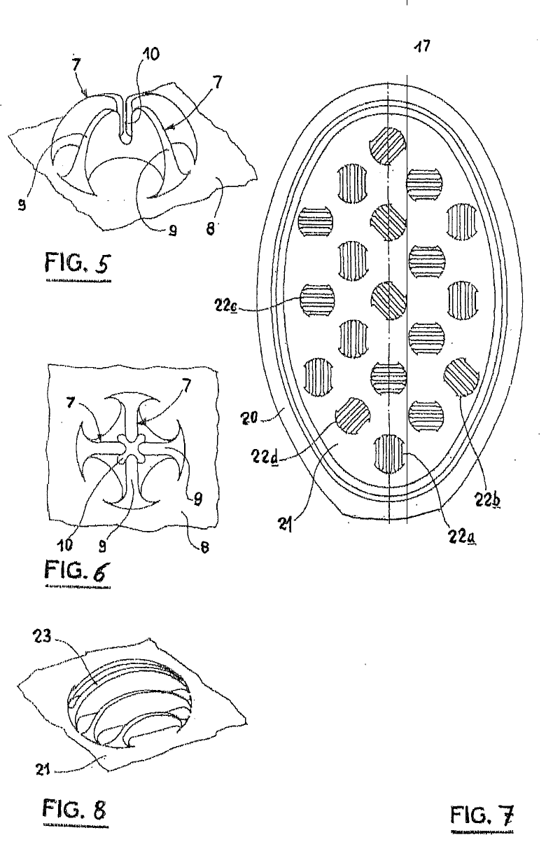

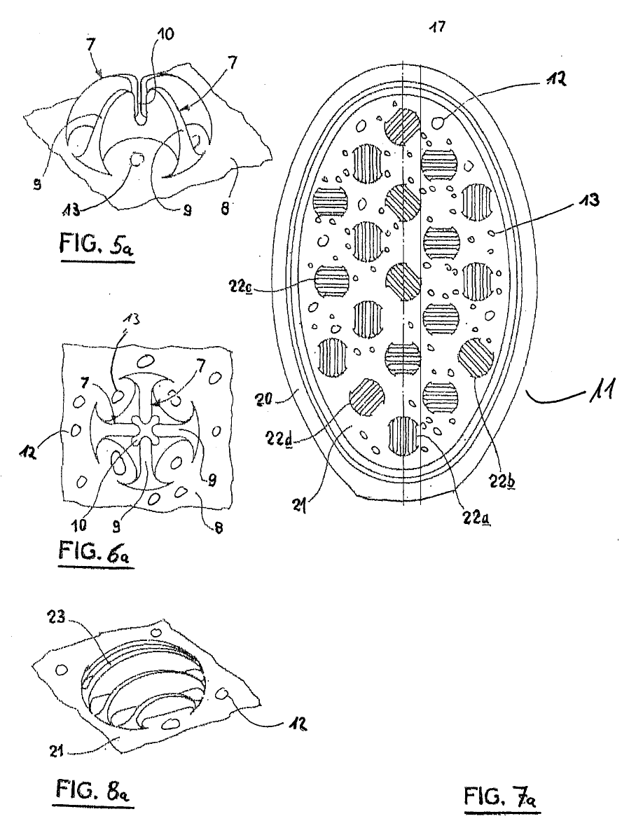

FIG. 5 a view similar to FIG. 4, with the two crossed lamellas being provided at their point of intersection with slits of a certain depth;

FIG. 5a a view similar to FIG. 4, with the two crossed lamellas being provided at their point of intersection with slits of a certain depth and having additional openings for the fluid media;

FIG. 6 a top view of two crossed lamellas from FIG. 5;

FIG. 6a a top view of two crossed lamellas from FIG. 5 with additional openings for the fluid media;

FIG. 7 a top view of a stimulation zone in accordance with the invention based on the second embodiment, with parallel arranged lamellas in the cones;

FIG. 7a a top view of a stimulation zone in accordance with the invention based on the second embodiment, with parallel arranged lamellas in the cones and additional openings for the fluid media;

FIG. 8 a perspective view on a larger scale of a cone as shown in FIG. 7, and

FIG. 8a a perspective view on a larger scale of a cone as shown in FIG. 7, with the small dosage openings.

FIG. 1 shows an embodiment of the manual device (1) in the form of a 5-finger glove. The glove has stimulation zones (11) on all fingertips of the interior surface of the hand and on the heel of the hand. In this execution, the materials used in the stimulation zones may involve, for example, those made of natural fibers such as, e.g., cotton, viscose, flax, coconut, sisal or sheep's wool or similar, or may involve chemical fibers.

FIG. 2 shows an additional embodiment of the manual device. Here, it involves a glove in which the thumb and the other four fingers are arranged together in a pocket. The entire bottom part of the glove is designed as a stimulation zone. To this end, soft fiber materials may be used in accordance with FIG. 1, or with the embodiments in accordance with FIGS. 3 through 8.

FIG. 2a shows an additional embodiment of the manual device. Here, it involves a glove in accordance with FIG. 2. Outlet openings are formed within the stimulation zone (11). These outlet openings are connected to the hose system of a dispenser reservoir.

In FIGS. 3 and 4, a stimulation zone for the stimulation of the surface of the skin, in particular of the female breast, is shown in its entirety with 11. The border 2 may be made of any suitable materials, e.g. of elastic pliable plastmasses. On one side of the border there is an elongated hollow space whose cross section is essentially elliptical. A pliant support base 4 is arranged in the interior of the aforementioned hollow space from which the cones 5a, 5b protrude that serve the stimulation of the surface of the skin.

In this example, the support base 4 and the cones 5a are formed as one piece by means of a molding process and are made from a rubber-like soft material. The soft support base 4 consists of a soft plate with an elliptical shape whose surface is located slightly higher than that of the hollow space existing in the border 2. Therefore, after being placed into the border 2, the soft support base 4 has a bent shape that is convex towards the exterior.

The shape of the cones 5a is exactly identical to that of the cones 5b, only their angular direction is different. Seen from above, the cones 5a, 5b have the shape of an X, with the two crossed lamellas 6 that form the cones being at a right angle to each other. The cones 5a, 5b have a symmetric shape with regard to an axis that runs through the point of intersection of the two crossed lamellas. The two crossed lamellas 6 of the cones are essentially arranged at a right angle on the soft support base 4, with each of them essentially having the shape of a circle segment that is connected to the soft support base through the bowstring. In the example at hand, the maximum height of the crossed lamellas 6 is 2 to 15 mm, their maximum length, 2 to 20 mm, and their maximum thickness, 1 to 3 mm.

The cones 5a, 5b are arranged in accordance with a square loop pattern, with a lateral length of 1 to 11.2 mm. Of the two crossed lamellas 6 of the cones 5a, one lamella is arranged parallel to the device axis in a longitudinal direction in FIG. 3. The two crossed lamellas of the cones 5b, on the other hand, form an angle of 45° with the device axis 17. Thus, the crossed lamellas of the cones 5a have an angular dislocation of 45° against the crossed lamellas of the cones 5b.

If the manual massage device as described is moved on the surface of the skin parallel to its longitudinal axis 17, the strain on the cones 5a is exerted in the longitudinal direction of one of their two crossed lamellas while the strain on the cones 5b takes place between the two crossed lamellas within the V-shaped enclosed angle. Thus, the two crossed lamellas of the cones 5b are strained laterally and therefore show less bend resistance than the lamellas 5a that are strained in their longitudinal direction. If the manual massage device 1 is moved parallel to its axis 17, the cones 5a are therefore less flexible than the cones 5b due to their angular arrangement. Therefore, upon contact with the skin, the cones 5a appear “harder” and the cones 5b, “softer”.

Thus, if a straight-moving stimulation takes place and one moves the manual massage device 1 parallel or perpendicular to its axis 17, the skin zone on which the device is moving is subjected to a multitude of aligned cones 5a and 5b that alternate between being more flexible and less flexible. The friction of the skin with the row of cones creates wavy or sinus-shaped impressions on the skin that change in dependence of the successive cone rows 5a, 5b. Thus, this stimulation is very effective and creates a corresponding hyperemia in the treated skin zone which promotes the penetration of various creams, lotions, oils or mixtures with pharmaceutical agents that are used.

In FIG. 3a, the larger outlet openings 13 are shown in the support base 4. The smaller outlet openings can be seen directly around the cones 5a and 5b. They serve the micro-dosing upon contact of the skin with the lamellas.

In FIG. 4a, two crossed lamellas (6) are shown on the support base (4). The form of the cones 5a is exactly identical with that of the cones 5b, only their angular direction is different. Seen from above, the cones 5a, 5b have the shape of an X, with the two crossed lamellas 6 that form the cones being at a right angle to each other. The cones 5a, 5b have a symmetric shape with regard to an axis that runs through the point of intersection of the two crossed lamellas. The two crossed lamellas 6 of the cones are essentially arranged at a right angle on the soft support base 4. The outlet openings (13) for the micro-dosing lie within the cross points.

FIGS. 5 and 6 show embodiments of the cones of FIGS. 3 and 4 consisting of crossed lamellas. The two crossed lamellas 7 of FIGS. 5 and 6 are at a right angle to each other, as are the crossed lamellas 6 of FIGS. 3 and 4. They each have essentially the shape of a circle segment that is connected to the soft support base 8 by means of its bowstring. The surface surrounding the edges of the two crossed lamellas 7 has essentially the shape of a hemisphere. Seen from above, the lower ends of the two lamellas become wider. In the same manner, the central part of the two crossed lamellas 7 broadens in the direction of the zone that is connected to a soft support base 8 (FIG. 6). The lamellas are incised at their intersection point up to two thirds of their height, with the two slits 10, as can be seen in FIG. 6, having the shape of an X and being dislocated by 45° relative to the two crossed lamellas 7.

The cones consisting of the two crossed lamellas 7 have essentially the same stimulation effect as the cones of FIGS. 1 and 2, except that the two slits 10 make the cones softer.

FIGS. 5a and 6a show the different lamellas of FIGS. 5 and 6 with the outlet openings (12 or, respectively, 13). While in FIG. 5a, only the outlet openings (13) for micro-dosing are formed, FIG. 6a also shows the outlet openings (12) for large-area dosing in addition to the outlet openings (13) for micro-dosing.

FIGS. 7 and 8 show another embodiment of a massage area in accordance with the invention. In the border 20, there is an essentially circumferential hollow space in which a soft support base 21 is imbedded with its circumference. Four groups of cones 22a, 22b, 22c, 22d protrude on the soft support base 21. The cones 22a, 22b, 22c, 22d are produced as one piece together with the soft support base 21 from a soft elastic rubber-like material.

The cones are arranged on the soft support base 21 in a loop-shaped square pattern. The cones 22a, 22b, 22c, 22d all have the same shape and differ only in their relative angular direction. The cones 22a, 22b, 22c, 22d consist of four essentially parallel lamellas 23 that are arranged on the soft support base 21 at a right angle. Each lamella 23 has the shape of a circle segment and is connected to the soft support base 21 by means of its bowstring. The surface enveloping the four lamellas 23 of a cone has the shape of a spherical cap. The thickness of the lamellas 23 increases slightly towards their ends.

As can be seen in FIG. 7, the lamellas of the cones 22a run parallel to the brush axis 24. The lamellas 23 of the cones of the same group 22a, 22b, 22c, 22d are rotated by 45° or a multiple of 45° relative to the lamellas 23 of the cones of another group. The cones of one group alternate with the cones of another group on the soft support base.

If the manual device is moved on the surface of the skin parallel to the device axis 17, the cones 22a are strained in the longitudinal direction of the lamellas 23 while the strain on the cones 22c occurs perpendicularly to the sides of the lamellas 23. The cones 22b and 22d are also strained laterally, but at an angle of 45°. The laterally strained lamellas 23 of the cones 22b, 22c, 22d therefore have less bend resistance than the lamellas of the cones 22a which are strained in longitudinal direction. Therefore, during a movement of the device parallel to its axis 17 on the surface of the skin, the cones 22a appear harder than the cones 22b, 22d and the latter in turn again slightly harder than the cones 22c.

The stimulation effect that is achieved by a manual device in accordance with the invention is analog to that of a device in accordance with FIGS. 3 and 4. It must be observed that the device in accordance with the invention

in either embodiment will not lead to any abrasions nor to any injuries of the skin layer due to friction even if a vigorous massage is carried out because the cones 5a, 5b, 2a, 22b, 22c, 22d are made of a soft material and the crossed or uncrossed cones have rounded shapes.

In FIG. 7a, the outlet opening for micro-dosing is shown on the stimulation zone (11) next to the outlet openings (12) for the large-area distribution of the fluid medium around the cones (5a, 5b, 22a, 22b, 22c, 22d).

The [missing part or parts] for an individual system (23) consisting of lamellas with the outlet openings (12) for micro-dosing is again shown in detail.

Textile fabrics for stimulation purposes within the framework of the invention at hand are to be understood, among others, as those with parts protruding from the surface of the fabric.

From DE-OS 2338486, a fabric has been known in particular for towels, with elevations protruding from the web in the form of naps, loops or bows that are covered with a synthetic material so that these elevations exert a massaging effect on the skin. The elevations are formed with the aid of braids or strips whose material differs from the textile fabric and which are attached to the textile fabric, in particular by way of sewing. Attaching the braids or strips on at least one surface of the textile fabric is easy during the manufacturing process, and the most varied braids or strips can be attached to the same fabric depending on the massage purpose and the demands of the user. Thus, different massage effects can be achieved thereby as well, depending on the needs, and it is even possible to attach different braids next to each other in alternating fashion on one single towel. Optimal massage effects can be obtained thereby.

The braids or strips are preferably made of natural fibers, in particular sisal or loofah. But alternatively or additionally, the braids may also be made of a synthetic material. A particularly good massage effect is achieved if the surfaces of the braids are coarse.

The fabric produced in this manner may be used, e.g., as a washcloth, a glove, a massage bath glove, a massage cloth, in particular for special facial massages, belts, massage cuffs or for the manufacture of bath attire, e.g. bathrobes, or in conjunction with other massage devices. An embodiment of the invention will be described in detail in the following.

Braids or strips that are lying parallel to each other and that protrude from the surface of the towel are sewed in this fashion onto one or both surfaces or, respectively, onto the sides of the fabric of a towel.

Alternatively, these braids or strips may also cross each other and be located at different distances from each other. The diameters of the braids or strips are the same or different. Moreover, the braids or strips may have bulging parts and/or coarse surfaces in order to increase the massage effect.

In an additional execution in accordance with the invention which is not shown here, the manual device involves one made of a soft material that consists of an upper and a lower part and forms an interstice that is intended to accommodate a hand, with at least two separate openings being provided for the fingers of the hand and with areas being formed at least in the area of the palm and of the fingers on which stimulation areas are provided, with the dimensions selected in such a way that the soft material is designed in overlapping fashion on the right and on the left of the openings for the hands in order to cover the body of the person.

Another subject of the invention at hand is the stimulation of body parts for a cosmetic alteration of at least one breast of a female person, with the growth of the stimulated breast being purposefully stimulated, especially by means of manual stimulation, for a cosmetic size correction of the breast in question. In this manner, an increased breast size can be purposefully achieved without surgical measures and the disadvantages connected therewith.

Preferably, the stimulation may occur in chronologically spaced stimulation intervals across a total period of 2 to 12 weeks, in particular four weeks, depending on the desired stimulation result, which will initially lead to a pulling sensation in the breast during the stimulation period through which the onset of the growth of the breast is signaled because the breast glands are stimulated to grow by the massage.

Within the first three weeks of the treatment, only a minor size change will be noticeable. However, from the fourth week of the stimulation on, a size increase will be clearly visible.

In accordance with the invention, the stimulation may occur for a period of 5 to 60 minutes, in particular 15 to 35 minutes per stimulation, depending on the desired stimulation result. Particularly preferable is an interval of 15 to 25 minutes.

Advantageously, the massage may occur in each case linearly from the exterior of the breast to the center of the breast so that the massaging can proceed either simultaneously in star-shaped concentric fashion or successively, and/or alternating from left to right, top to bottom, from right to left, etc.

In this regard, the massage may occur in circular motions at the various locations in different directions, but any distribution pattern with regard to chronological or spatial distribution and direction is possible as well.

The mammilla is omitted from stimulation by the massage. On the hand, in order to prevent any physical irritations and discomfort on the part of the person, but also because no growth is possible there.

In accordance with the invention, the massage may occur at different lengths and/or at different intensity for the two breasts, depending on the anatomic conditions of the person involved, so that the growth to be achieved can be precisely adjusted to the wishes of the person in question.

An additional subject of the invention at hand is the use of the manual device for the stimulation of body zones, in particular of the female breast.

1-28. (canceled)

29. A manual device, comprising:
a device body formed of a soft material, said body including an upper part and a lower part defining an opening therebetween configured to accommodate at least one hand, and having at least two separate openings formed therein for receiving fingers of the hand; and
areas defined at least in a region of a palm of the hand and at the fingers, whereon stimulation areas are arranged.

30. The manual device according to claim 29, wherein said stimulation areas are formed of a material selected from the group consisting of a soft elastic material, a soft elastic textile material, a soft natural material, and a soft elastic synthetic material.

31. The manual device according to claim 29, wherein said stimulation areas are formed of terry cloth.

32. The manual device according to claim 29, wherein at least one active side consisting of stimulation areas is provided with a multiplicity of protruding cones made of soft elastic deformable material, wherein said cones are formed of crossed or uncrossed lamellae divided into at least two common groups according to an angular arrangement of their lamellae, with said cones of one common group on said active side being arranged in alternating fashion with said cones of the other common group.

33. The manual device according to claim 32, wherein said cones are manufactured in one piece together with a support base thereof formed of a rubber-type soft material.

34. The manual device according to claim 33, wherein said lamellae forming said cones are disposed on said support base substantially perpendicular and have the shape of an arc segment, being connected to said soft support base at a secant thereof.

35. The manual device according to claim 32, wherein a surface enveloping the borders of said lamellae belonging to each cone is substantially shaped as a spherical cap.

36. The manual device according to claim 32, wherein said stimulation areas of said cones are formed with two crossed lamellae, forming an X in plan view, with an angular direction of said crossed lamellae of said cones belonging to one group differing from an angular direction of said crossed lamellae of said cones belonging to another group, in that the lamellae are rotated about an axis running through an intersection point of said two crossed lamellae of said cones.

37. The manual device according to claim 36, wherein said two cones are symmetric relative to the axis running through said intersection point of said two crossed lamellae.

38. The manual device according to claim 36, wherein said two crossed lamellae of each said cone are disposed substantially perpendicular to one another and said lamellae of said cones of one group are rotated by substantially 45° relative to said lamellae of said cones of another group.

39. The manual device according to claim 36, wherein said crossed lamellae are formed with an incision at the point of intersection thereof up to a part of a height thereof.

40. The manual device according to claim 32, wherein said cones are formed with non-crossed lamellae disposed substantially parallel to one another, and wherein said lamellae of said cones of one common group are arranged at an angle relative to said lamellae of said cones of another said common group.

41. The manual device according to claim 32, wherein said cones are defined in four groups, and wherein said lamellae of said cones of one group are rotated by substantially 45° or a multiple of substantially 45° relative to the angular direction of said lamellae of said cones of another group.

42. The manual device according to claim 32, which comprises a support base of said cones disposed in an interior of a rigid border.

43. The manual device according to claim 32, wherein the device is configured as a stimulation glove in the form of a soft pocket, and said cones protrude on at least one side of said glove.

44. The manual device according to claim 29, wherein the device is configured as a stimulation glove in the form of a soft pocket, with cones protruding on at least one side of said glove.

45. The manual device according to claim 32, which comprises a container for holding water-soluble products on said upper part, and wherein said cones have a support base formed with holes communicating with said container.

46. The manual device according to claim 45, wherein said container is configured to hold a water-soluble product selected from the group consisting of soap, a soap bar, lotion, cream, or mixtures thereof.

47. A method of stimulating a human breast, which comprises:
providing the manual device according to claim 29; and
purposefully stimulating the breast by massaging the breast for the purpose of a cosmetic size correction of the breast.

48. The method according to claim 47, which comprises stimulating the breast at time intervals through a given total treatment period in accordance with a desired stimulation result.

49. The method according to claim 48, wherein the total treatment period is approximately four weeks.

50. The method according to claim 48, which comprises setting the time interval to between 5 and 60 minutes.

51. The method according to claim 50, which comprises setting the time interval to between 15 and 35 minutes.

52. The method according to claim 48, which comprises setting the time interval to between 15 and 25 minutes.

53. The method according to claim 48, which comprises stimulation a breast tissue from the outside towards a center.

54. The method according to claim 48, which comprises omitting the mammillae from the stimulation.

55. The method according to claim 48, which comprises stimulating the two breasts occurs in each case within a time interval of 2 to 12 weeks, depending on prevailing anatomical preconditions of the person in question.
